(19) United States
(12) Patent Application Publication
(10) Pub. No.: US 2006/0023459 A1
(43) Pub. Date: Feb. 2, 2006

(54) Composite framework of lampshade and manufacturing method

(76) Inventor: Zhao-Cheng Chen, Guangdong (CN)

Correspondence Address: CHARLES E. BAXLEY, ESQ., 90 JOHN STREET, THIRD FLOOR, NEW YORK, NY, 10038, US

(21) Appl. No.: 11/087,245

(22) Filed: Mar. 23, 2005

(30) Foreign Application Priority Data
Jul. 27, 2004 (CN) CN 200410050812.3

(51) Int. Cl. F21V 15/00

(52) U.S. Cl. 362/362

(57) ABSTRACT

The present invention relates to a lampshade and manufacturing method, including how to manufacture the framework components and how to combine them together; said framework components include upper ring, low ring, linking members, ring connectors, upper and low socket adaptors; wherein said upper and low rings are made of circular steel bar in butt welding, and the ring plugs are welded on the stem of ring in uniform distribution, which is made of punched steel sheet by die; said upper and low socket bases of the framework are molded with plastic in one time; said linking members of the framework are made of punched steel sheet, which is plugged into the upper and low plastic socket bases with the both ends respectively; the plastic socket bases are connected to the upper and low rings together via the ring plugs; the combined lampshade framework appears into small top and big bottom. Said framework structure has high strength, not easy damage, and good looking feathers.

### BACKGROUND OF THE INVENTION

1. Field of the Invention

The present invention relates to a lampshade and manufacturing method, and more especially to a composite framework of lampshade and manufacturing method.

2. Description of Prior Art

According to the conventional desk lamps and floor lamps, most of them need to be furnished with lampshade, thereby not only function as collecting light, but also decorating. The lampshade is typically comprised of framework and mat coat covering on the framework, and the framework is typically simpler, it is consisted of an upper and a low iron rings and several linking members (rods or strips). Due to the simpler structure of the framework, there are some shortcomings existing like poor strength, easy damage, dull in look and so on. Especially on the connection process, the punched framework and the linking members are often remained with sharp raw edges; they are easy to scratch the workers, so it brings up inconvenience and danger.

### OBJECTS AND SUMMARY OF THE INVENTION

For overcoming the above said shortcomings of the prior art, it is therefore a main object of the present invention to provide a composite framework of lampshade and its manufacturing method to replace the prior art.

This object is achieved by a composite framework of lampshade provided of the present invention, within said composite lampshade framework includes a set of assembly components comprising upper ring and low ring, linking members and ring plugs, upper socket base and low socket base, wherein said ring plugs are respectively located on the upper and low rings, said ring plug extends a tough with a catching hole on the surface; said upper socket base has an U-shaped slot with a locking lug at the inside; the low socket base has an U-shaped slot with locking lug at the inside, on which there are a couple of catching hooks built for fastening the end of the linking member; said linking member is fixed in the U-shaped slot of the upper socket base with one end, the another end is locked on the catching hooks.

The technical project also includes that:

Said linking member connects to the low socket base via a catching adaptor; one end of the catching adaptor is built into frame, another is in U-shaped socket with a locking lug at the inside, so that the H-shaped end of the linking member is plugged into the U-shaped slot of said catching adaptor, and the frame end of the catching adaptor is launched into the catching hooks of the low socket base.

On the upper and low rings of the framework there are proper number of balls pre-set; coordinating to them, the upper and low socket bases have a socket built on the front end for holding the ball in place; said upper and low socket bases are shaped with G-shaped cross-section; the linking member has a rectangle hole built on each end respectively, so that the rectangle holes can hook on the G-shaped socket bases (upper or low).

On the upper and low rings of the framework there are proper numbers of splines preset; coordinating to them, the upper and low socket bases have an open through rectangle hole respectively built on one end, and the each open rim has a beard set upon, and the another end of the socket base has a blind rectangle hole; the splines of the upper and low rings are plugged into the open through rectangle holes respectively, and the linking member is plugged into the blind rectangle holes of the upper and low socket bases with the both ends individually.

On the upper and low ring of the framework there are respectively proper numbers of balls and splines preset on different sides; coordinating to them, said upper and low socket bases are preset blind rectangle hole or ball socket on the front side, and on the other sides a blind rectangle hole is individually built; by plugging balls into the ball sockets respectively, and by plugging splines into the blind rectangle holes, the rings are combined with the socket bases respectively; the linking members connect to the upper and low socket bases with the both ends plugged into the blind rectangle holes.

Said linking member is in strip or rod with H-shaped ends or rectangle hole ends, or one rounded end, another in H-shaped end or rectangle hole end or double rectangle holes end.

The present invention's manufacturing method includes how to manufacture the framework components and how to combine them together. Said framework components include upper ring, low ring, linking members, ring connectors, upper and low socket adaptors. Wherein said upper and low rings (including circle and polygon) are made of circular steel bar in butt welding, and the ring plugs are welded on the stem of ring in uniform distribution, which is made of punched steel sheet by die; said upper and low socket bases of the framework are molded with plastic in one time; said linking members of the framework are made of steel sheet, which is plugged into the upper and low plastic socket bases with the both ends respectively; the plastic socket bases are connected to the upper and low rings together via the ring plugs; the combined lampshade framework appears into small top and big bottom. On the other hand, said upper and low rings are welded with proper number of small steel balls or steel splines in uniform distribution for linking to upper and low plastic socket bases.

The present invention above-mentioned has following feathers: 1) multiple methods in connection for meeting the need of combining variant shaped lampshade. 2) High strength without easy damaging. 3) Good looking.

### BRIEF DESCRIPTION OF THE DRAWINGS

FIG. 1 is a cross-sectional view showing the combined framework of the present invention.

FIG. 2 is a part enlarged view showing part A of FIG. 1.

FIG. 3 is a solid view showing the connection of the ring plug and the upper ring of the present invention.

FIG. 4 is a scheme showing the upper socket base of the present invention.

FIG. 5 is a scheme showing the catching adaptor of an embodiment of the present invention.

FIG. 6 is a scheme showing the low socket base with double catching hooks of the present invention.

FIG. 7 is a scheme showing the low socket base in another embodiment of the present invention.

FIG. 8 is a scheme showing the connection structure of the present invention.

FIG. 9 is a scheme showing the connection structure in the embodiment of the present invention diagram-1.

FIG. 10 is a scheme showing the connection structure in the embodiment of the present invention diagram-2.

FIG. 11 is a scheme showing the connection structure in the embodiment of the present invention diagram-3.

FIG. 12 is a scheme showing the connection structure in the embodiment of the present invention diagram-4.

FIG. 13 is a scheme showing the connection structure in the embodiment of the present invention diagram-5.

FIG. 14 is a scheme showing the connection structure in the embodiment of the present invention diagram-6.

FIG. 15 to FIG. 20 are schemes showing the linking members of the present invention.

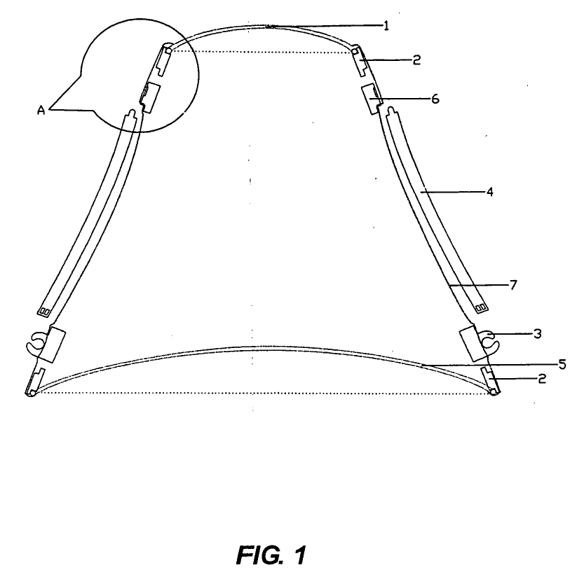

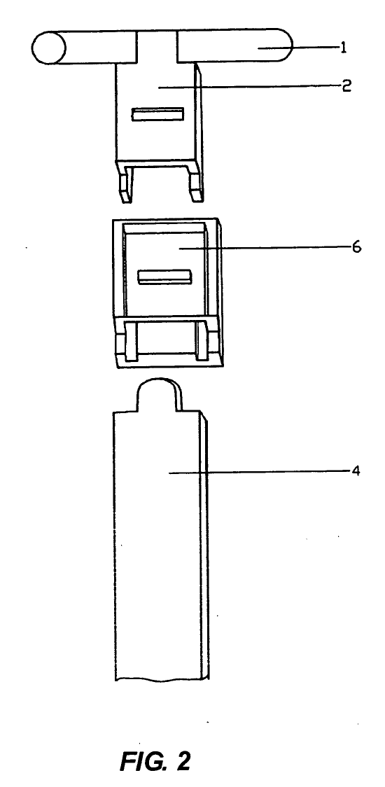

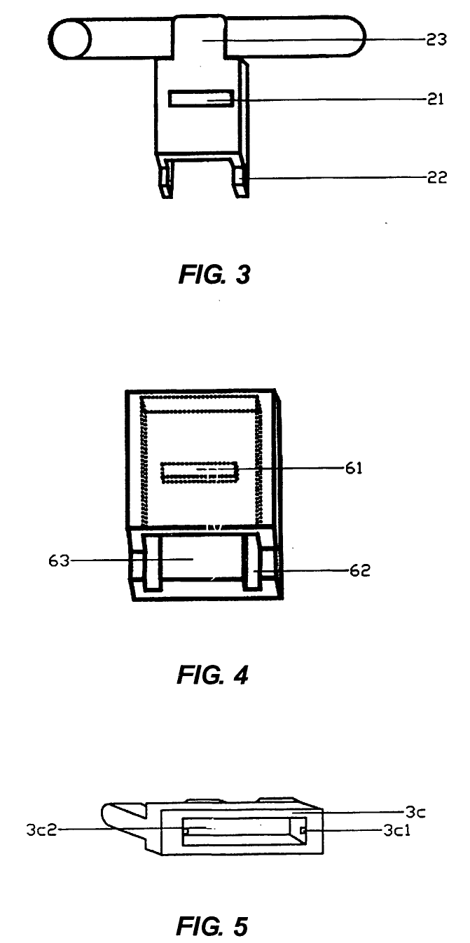

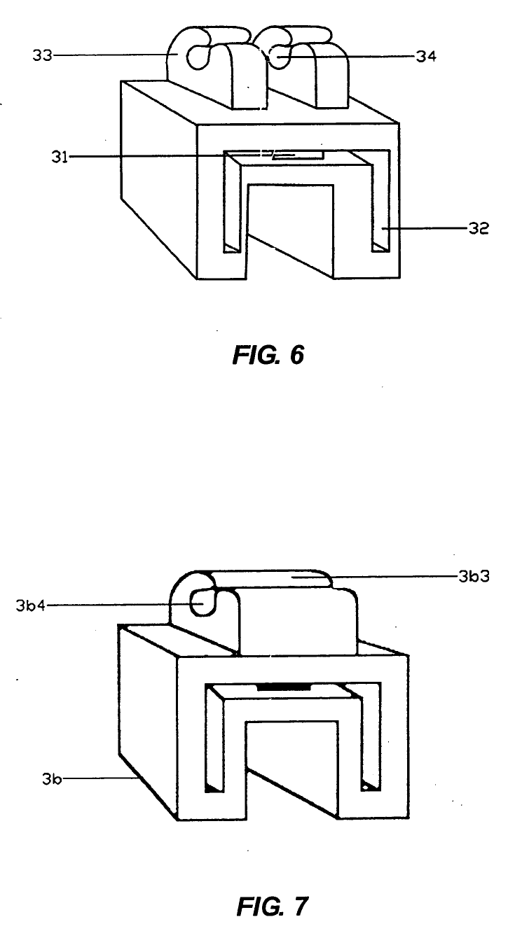

### DETAILED DESCRIPTION OF PREFERRED EMBODIMENTS

The composite framework of lampshade is comprised of upper ring and low ring, ring connectors and ring plugs, upper socket base and low socket base, wherein said ring plugs are respectively located on the upper and low rings, said ring plug extends a tough with a catching hole on the surface; said upper socket base has an U-shaped slot with a locking lug at the inside; the low socket base has an U-shaped slot with locking lug at the inside, on which there are a couple of catching hooks built for fastening the end of the linking member; said linking member is fixed in the U-shaped slot of the upper socket base with one end, the another end is locked on the catching hooks.

The upper ring 1, ring plugs 2, upper socket bases 6, low socket bases 3, ring connectors 4 and low ring 5 can be combined into a frame-work of lampshade. The ring plug 2 extends a tough 22, which also can be directly welded on the upper or low rings 12.

Said ring plug 2 has a U-shaped slot consisted of a bottom surface with a catching hole 21 and two side pieces 22. The upper socket base 6 has a catching socket with a locking lug for catching into the catching hole 21 of the ring plug 2, and a guiding slot 62 built upon the back side of the catching socket for guiding the side pieces 22 of the ring plug 2 sliding and locking in, and the socket base 6 also has a slotted hole 63 at inside.

Said low socket base 3 has a catching socket 32 with a locking lug 31 for catching into the catching hole 21 of the ring plug 2 as above-described in the upper socket base 6. There are a couple of catching hooks 33 built upon the low socket base 3 to form holding eyes 34 at insides.

The linking member 4 is a bar with round head 42 at top end and a through-hole 41 at bottom end. The top end can be plugged into the slotted hole 63 of the upper socket base 6, by pushing up the lampshade cloth; the bottom end of the linking member 4 with the through-hole 41 is hooked up the catching hooks 33 of the low socket base 3 to finish a combination one time.

In combination, firstly plug the upper socket bases 6 on the ring plugs 2 respectively. The low socket bases 3 are respectively attached on the lampshade cloth 7 by extending the double catching hooks 33 out from the preset holes, and then plugged with the ring plugs 2. The linking members 4 passes through the preset holes on the lampshade cloth with the round head 42 to plug into the upper socket base 6, and another end-through-hole end 41 is hooked on the double catching hooks 33 and located in the socket eyes 34. Following this sequence, one by one, install all the linking members 4 on until finishing all the combination process.

In this structure of the framework, said ring plug 2 can be a small ball 2a or a small spline 2c replacing.

The upper socket base 6 or the low socket base 3 can be double catching hooks 3a as above-mentioned, or a single catching hook 3b, or a G-shaped base 3d, or a rectangular base 3e, or a cylinder base 3f replacing.

The linking member 4 can be in single through-hole end 4a, or in double through-holes end 4b or both single through-hole ends 4c, or flat end 4d, or H-shaped end 4e replacing.

When the small balls 2a or the small splines 2c are welded on the upper or low rings 1 or 5, cooperate to the G-shaped socket base 3d, or rectangular base 3e, or cylinder base 3f, and different linking members to combine a desired lampshade framework.

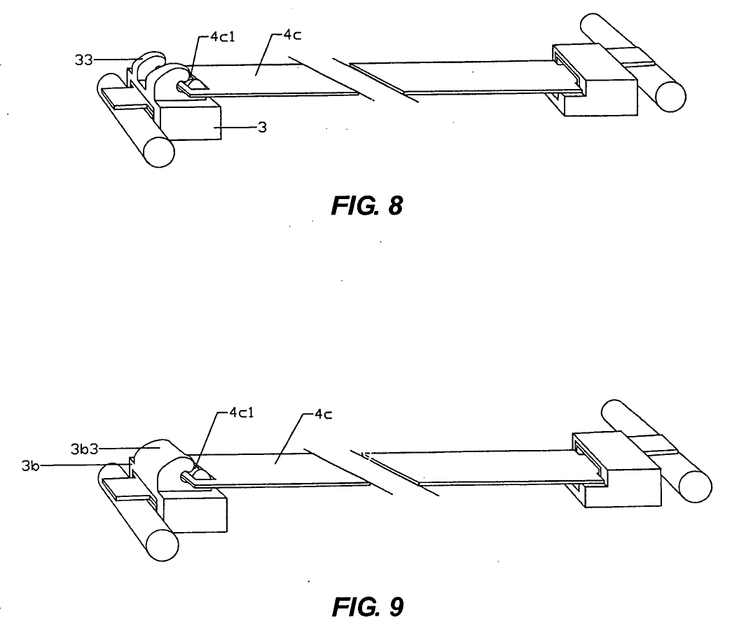

Other Embodiment 1 (as Shown in FIG. 8):

FIG. 8 illustrates that a linking member 4 is in a single through-hole end 4a structure, thereby to be hooked in the socket eyes 34 of the low socket base 3 with the single through-hole 441.

Embodiment 2 (as shown in FIG. 9):

FIG. 9 illustrates that a linking member in single through-hole end 4c structure cooperates to a socket base in a single catching hook 3b structure, by hooking the through-hole 4c1 in the socket eye 3b4 at all.

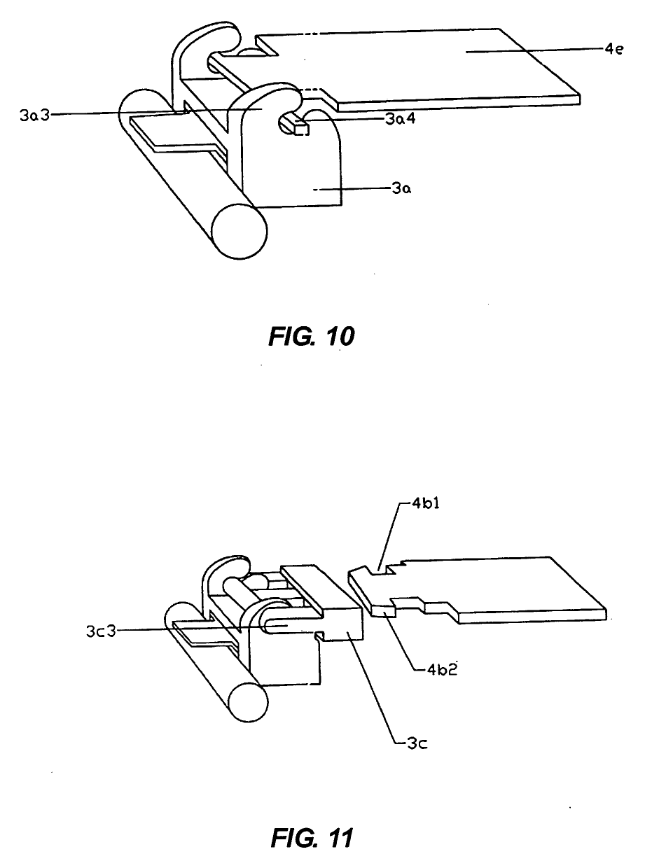

Embodiment 3 (as Shown in FIG. 10):

FIG. 10 illustrates that the linking member used in H-shaped end 4e structure is in both ends, and the socket base is in double catching-hook structure, thereby to hook in the socket eyes 3a4 of the double hooks with the double H-shaped ends 4e.

Embodiment 4 (as Shown in FIG. 5 and FIG. 11):

FIG. 5 shows a socket adaptor 3c having proper number of catching pins 3c1 built on the rim of socket, and slotted eye 3c2 and pivoting arms 3c3. Hang the pivoting arms 3c3 on the socket eyes 34. The double plugging linking member 4b has two notches 4b1 at both opposite sides individually, and the tip end is mitered with both bevels 4b2 for guiding the head into the slotted eye 3c2 and catching the both notches 4b1 in place with the catching pins 3c1.

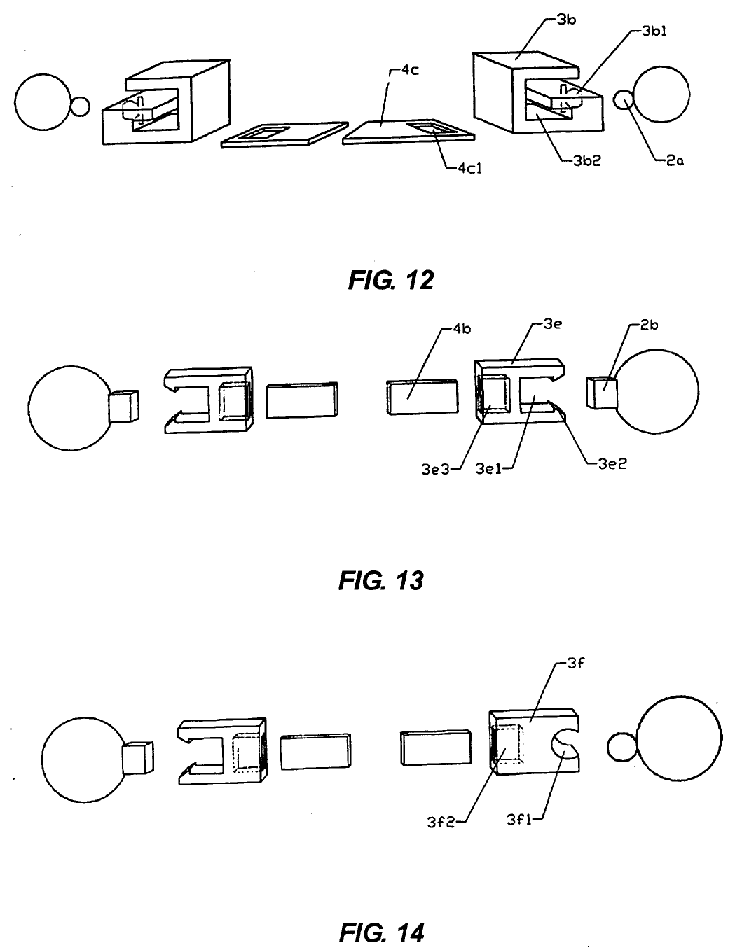

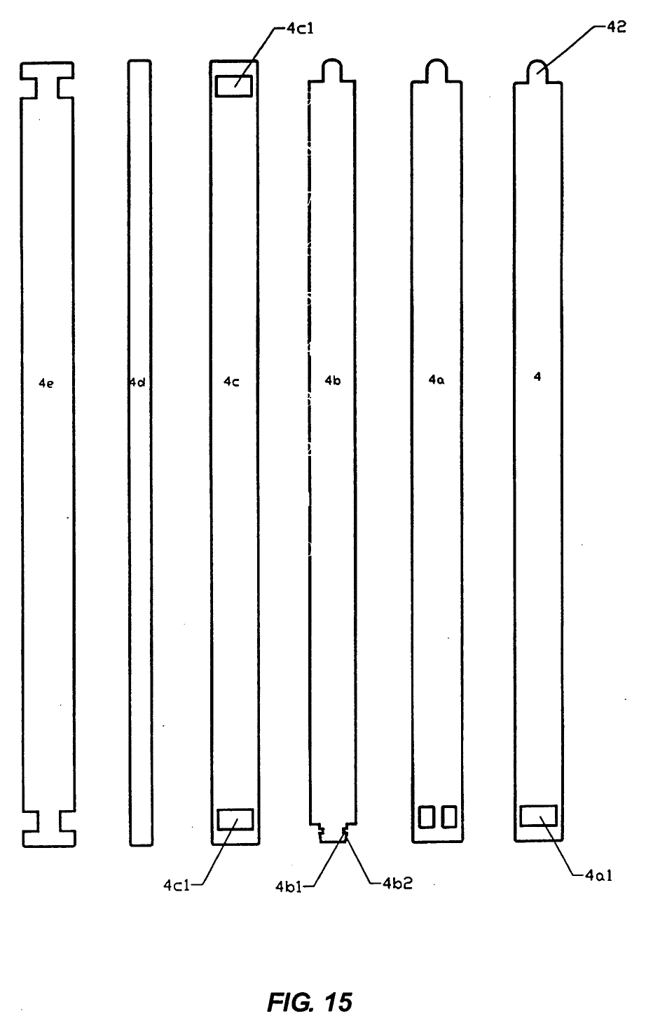

Embodiment 6 (as Shown in FIG. 12):

FIG. 12 illustrates that the linking member connects to a G-shaped base 3d structure, wherein a socket 3d1 is built upon the front end for plugging the small ball 2a in, and a deep slot 3d2 for hooking the through-hole 4c1 in.

Embodiment 7 (as Shown in FIG. 13);

FIG. 13 illustrates that a rectangular base 3e is used for connecting with the linking member, and appears to C-shaped double clamp including an open through rectangle-hole 3e1, two beards 3e2 on the open rims, a rectangle blind-hole 3e3. Push the open through rectangle-hole 3e1 up from the bottom of the spline 2c so that the spline 2c slides into the inside and retained in there by the two beards 3e2. On the other side, the flat linking member 4d is plugged into the rectangle blind-hole 3e3 and held in.

The framework includes upper ring, ring plugs, upper socket bases, low socket bases, linking members and low ring. Wherein ring plug is spline welded on the upper and low rings.

The ring plug is in U-shaped with a catching hole on the main surface surrounded by two side pieces at both sides. The upper socket base is in slot structure having a catching lug for locking into the catching hole of the ring plug, and a guiding slot for sliding the side pieces of the ring plug in, and a socket eye built upon.

The low socket base is in slot structure having a catching lug for locking into the catching hole of the ring plug. The low socket base also has two set of catching hooks to form slotted eyes at insides.

The linking member has a round head top end and a through-hole bottom end. The top end can be directly plugged into the socket of the socket base, and then push up the lampshade cloth so that the bottom end can be hooked in the slotted eyes of the low socket base.

Wherein said upper and low socket bases are made of plastic in injection molding without raw edge, and a bit dimension error. Plastic has elastic feather, and more facilitating to combination, meanwhile looked good.

Said upper and low rings are welded with proper number of small steel balls or steel splines in uniform distribution for linking to different style of upper and low plastic socket bases to combine different composite framework lampshade.

I claim:

1. A composite framework of lampshade constructed of frame-work components, wherein said framework includes upper ring, ring plugs, upper socket bases, low socket bases, linking members and low ring, therein ring plug is fixed on the upper and low rings, and appears to U-shaped structure having a catching hole on the main surface; the upper socket base has a U-shaped slot with a catching lug for plugging the ring plug in; the low socket base has a U-shaped slot with a catching lug, and a U-shaped plug slot; the linking member is plugged into the U-shaped slot of the upper socket base with one end, and another end is plugged into the U-shaped plug slot of the low socket base.

2. A composite framework of lampshade as claimed in claim 1, wherein said linking member connects to the low socket base through the slotted adaptor; one end of the slotted adaptor is in frame, another end is with a catching lug for plugging the H-shaped end of the linking member, on the other side, the frame end of the slotted adaptor is plugged into the U-shaped slot of the low socket base.

3. A composite framework of lampshade as claimed in claim 1, wherein on the upper and low rings of the framework there are proper number of balls pre-set; coordinating to them, the upper and low socket bases have a socket built on the front end for holding the ball in place; said upper and low socket bases are shaped with G-shaped cross-section; the linking member has a rectangle hole built on each end respectively, so that the rectangle holes can hook on the G-shaped socket bases (upper or low).

4. A composite framework of lampshade in claim 1, wherein on the upper and low rings of the framework there are proper numbers of splines preset; coordinating to them, the upper and low socket bases have an open through rectangle hole respectively built on one end, and the each open rim has a beard set upon, and the another end of the socket base has a blind rectangle hole; the splines of the upper and low rings are plugged into the open through rectangle holes respectively, and the linking member is plugged into the blind rectangle holes of the upper and low socket bases with the both ends individually.

5. A composite framework of lampshade in claim 1, wherein on the upper and low ring of the framework there are respectively proper numbers of balls and splines preset on different sides; coordinating to them, said upper and low socket bases are preset blind rectangle-hole or ball socket on the front side, and on the other sides a blind rectangle-hole is individually built; by plugging balls into the ball sockets respectively, and by plugging splines into the blind rectangle holes, the rings are combined with the socket bases respectively; the linking members connect to the upper and low socket bases with the both ends plugged into the blind rectangle-holes.

6. A composite framework of lampshade as claimed in claim 1, wherein said the linking member is in strip or rod with H-shaped ends or rectangle hole ends, or one rounded end, another in H-shaped end or rectangle hole end or double rectangle holes end.

7. A composite framework of lampshade as claimed in claim 1, wherein said linking member is rod.

8. A composite lampshade framework's manufacturing method as claimed in claim 1, wherein said manufacturing method includes how to manufacture the framework components and how to combine them together; said framework components include upper ring, low ring, linking members, ring connectors, upper and low socket adaptors; wherein said upper and low rings (including circle and polygon) are made of circular steel bar in butt welding, and the ring plugs are welded on the stem of ring in uniform distribution, which is made of punched steel sheet by die; said upper and low socket bases of the framework are molded with plastic in one time; said linking members of the framework are made of steel sheet, which is plugged into the upper and low plastic socket bases with the both ends respectively; the plastic socket bases are connected to the upper and low rings together via the ring plugs; the combined lampshade framework appears into small top and big bottom.

9. A composite lampshade framework's manufacturing method as claimed in claim 8, wherein said upper and low rings are welded with proper number of small steel balls or steel splines in uniform distribution for linking to upper and low plastic socket bases.

10. A composite lampshade framework's manufacturing method as claimed in claim 8, wherein said upper and low rings are in polygon.
